(19) United States
(12) Patent Application Publication
(10) Pub. No.: US 2006/0259558 A1
(43) Pub. Date: Nov. 16, 2006

(54) Method and program for handling spam emails

(75) Inventor: Wen Yi Yen, Taipei City (TW)

Correspondence Address: QUINTERO LAW OFFICE, 1617 BROADWAY, 3RD FLOOR, SANTA MONICA, CA, 90404, US

(73) Assignee: LITE-ON TECHNOLOGY CORPORATION, TAIPEI (TW)

(21) Appl. No.: 11/300,756

(22) Filed: Dec. 14, 2005

(30) Foreign Application Priority Data
May 10, 2005 (CN) CN200510070207.7

(51) Int. Cl. G06F 15/16

(52) U.S. Cl. 709/206

(57) ABSTRACT

A method for handling spam emails is provided. The method is executed by an email client computer connected to a first mail server and comprises the following steps. An email received from the first mail server is identified as a spam email or a valid email first according to at least one judgment condition. A number of spam emails received from the same sender identity as a sender identity of the email is then accumulated if the email is identified as a spam email. A warning message about the sender identity is then issued to a second mail server of the sender of the email or a network police if the number is larger than a threshold value.

### BACKGROUND

The present invention relates to a computer, and more particularly, to the handling of electronic mail.

The Internet today is overflowing with spam email, which is seriously problematic for internet users of and the internet industry as a whole. For example, Bill Gates of Microsoft receives 4 million spam emails everyday. The ratio of the number of spam emails to the total amount of e-mails was increased to more than 50 percent now. The total expense spent by global business to block spam email amounts to 8 to 10 billion dollars. The economic loss to the United States caused by spam email is almost 8 billion dollars a year. The internet users in mainland China receive a total of 46 billions of spam emails in a year, and the economic loss to China caused by spam email is second only to the US. Spam email causes so much damage that it may be considered a public enemy.

Spam blocking technology is divided into two categories. One category is built at the mail server side, and the other is built at the client side as a POP3 mail receiving program to block mail from unwelcome or unacceptable senders. The primary techniques at the mail server side, for example, are the Sender ID technique of the Microsoft company, the Domain Key technique of the Yahoo company, and other methods of comparing the mail context with some key words to identify spam email. The primary techniques at the POP3 client side are using a black list, white list or key words set by the user to filter out the spam email.

The technique to block spam at the mail server side is still under development, but there is still a long way to go. For example, although Yahoo is satisfied with its Domain Key technique, the technique can only block 70% of spam email. Moreover, free mail boxes are so popular today, and spam email senders can deliver the spam emails through different paths. Only the receiver definitely knows which email is a spam email. Thus, the mail server cannot completely block all of the spam emails.

Many POP3 client programs (for examples, Outlook and Outlook Express of Microsoft, Eudora of Innovative Design Concepts in New Jersey) and webmail systems (for examples, Yahoo mail) provide fundamental functions, including black list, white list, and key words to filter out spam email. The performance of these techniques differs, but none of these techniques provides a function to automatically notify the receiver of the identity of the mail sender to determine if it is a spam email.

### SUMMARY

A method for handling spam email is provided. The method can be executed by an email client computer. An exemplary embodiment of the method comprises the following steps. An email is identified as a spam email or a valid email first according to at least one judgment condition. A number of spam email received from the same sender identity as a sender identity of the email is then calculated if the email is identified as a spam email. A warning message indicating the sender identity is then issued to a first mail server of the sender of the email or a network police if the number is larger than a threshold value.

A program for handling spam email is also provided. An exemplary embodiment of the program can be loaded into an email client computer for directing the email client computer to execute a method, the method comprising the following steps: an email is first identified as a spam email or not a span email according to at least one judgment conditions; a number of spam emails received from the same sender identity as a sender identity of the email is then calculated if the email is identified as a spam email; a warning message indicating the sender identity is issued then to a first mail server of the sender of the email or a network monitor if the number is larger than a threshold value.

### DESCRIPTION OF THE DRAWINGS

The invention can be more fully understood by reading the subsequent detailed description in conjunction with the examples and references made to the accompanying drawings, wherein:

FIG. 1 illustrates an embodiment of an email system according to the invention;

FIG. 2 is a flowchart illustrating an embodiment of a method for handling spam email according to the invention;

FIG. 3 is a flowchart illustrating an embodiment of a method for identifying a spam email;

FIG. 4a is an upper half of a flowchart illustrating another embodiment of a method for handling spam email according to the invention;

FIG. 4b is a below half of a flowchart illustrating another embodiment of a method for handling spam email according to this invention;

FIG. 5 shows an embodiment of an information table for holding some information of an email as a reference for the user to determine whether the email is a spam email.

### DETAILED DESCRIPTION

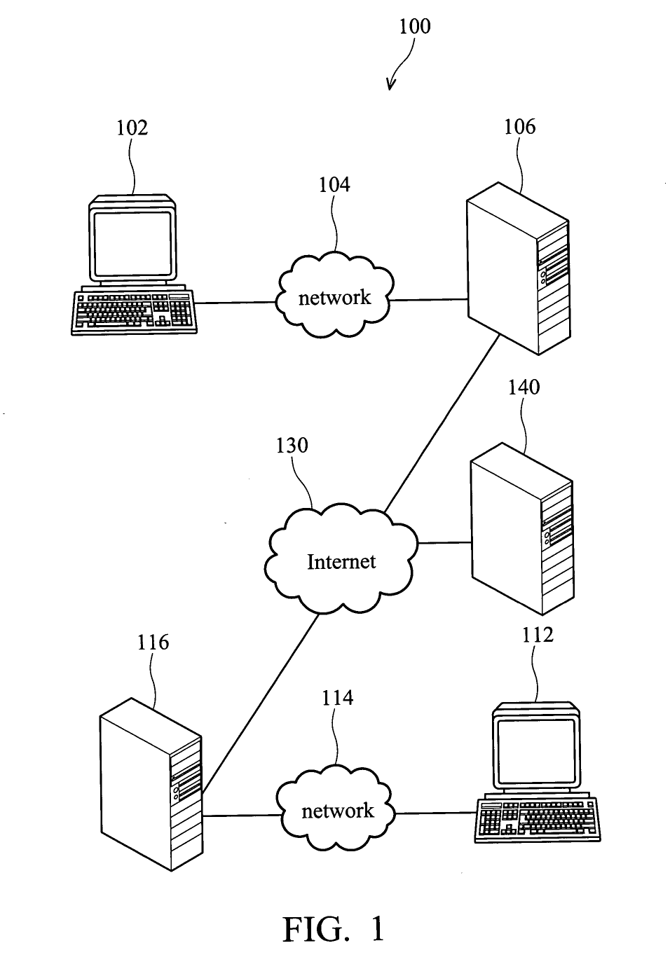

FIG. 1 illustrates an embodiment of the email system 100 according to the invention. A user of the email client computer 102 has an email box on the first mail server 106. Assume that an email sender uses the computer 112 to send an email to the user. The email is first transmitted from the sender computer 112 to the second mail server 116 of the sender computer 112 through a network 114. The email is then delivered by the second mail server 116 to Internet 130. The email is then routed to the first mail server 106 of the email client computer 102 through the Internet 130. After the email is received by the first mail server 106, the first mail server 106 stores this email according to its email address, which is the email address owned by the user of email client computer 102. The user can then download the email in the mail box of the user on the first mail server 106 into the receiver email client computer 102 through the network 104. Of course, network 104 and 114 can be local area network or wide area network such as the Internet. Additionally, the computer 140 is connected to the Internet 130 and owned by the network police who receive accusations of spam emailing for prosecuting criminally liable senders.

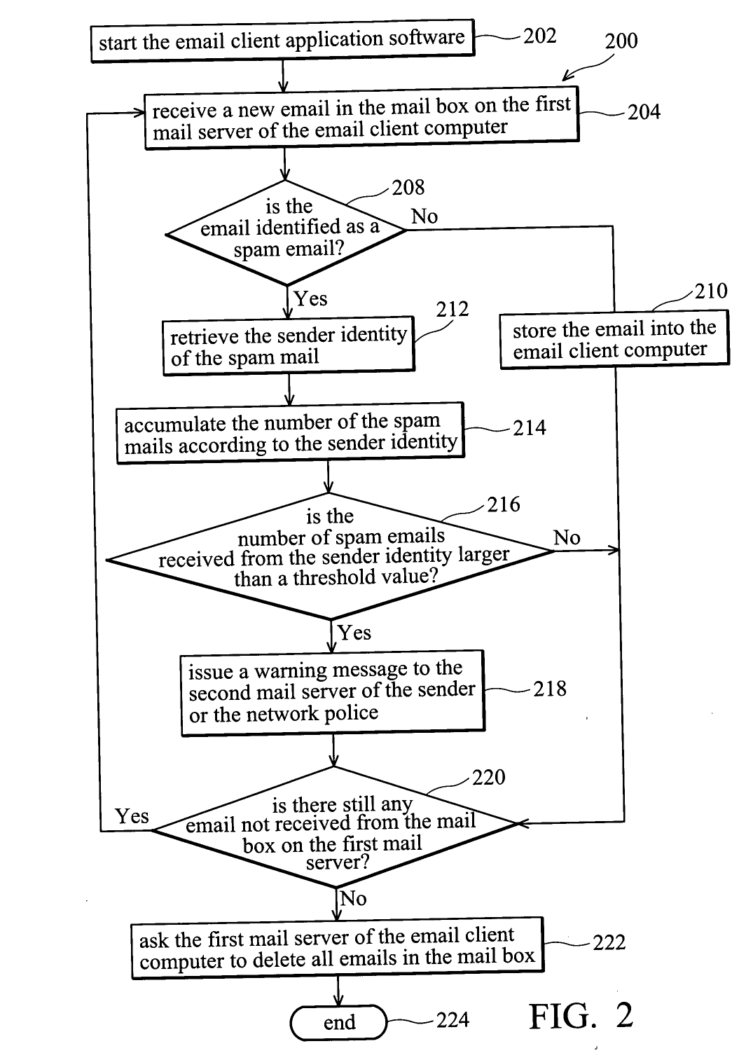

FIG. 2 is a flowchart illustrating an embodiment of a method 200 for handling spam email according to the invention. The user uses an email client application software, such as Microsoft Outlook, on the email client computer 102 in FIG. 1 to receive and send emails. At start, email client application software receives the emails in the mail box on the first mail server 106 through the connection between the email client computer 102 and the server 106. Method 200 can be executed by the email client software directly or by a plug-in module for the email client software. The steps of method 200 are detailed in the following paragraphs.

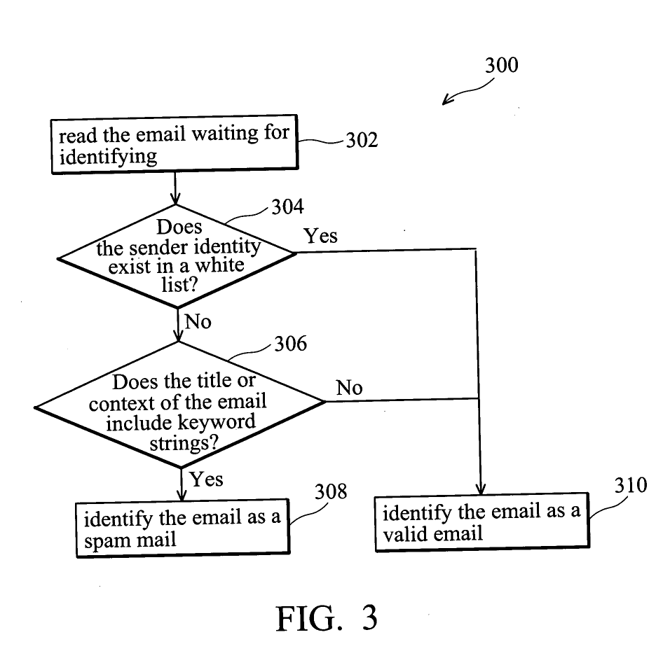

The method 200 starts with starting the email client application software in step 202. A connection is then made between the email client computer 102 and first mail server 106. Method 200 then starts to receive the emails in the mail box on the first mail server 106 in step 204. Each time an email is received, the method 200 identifies whether the email is a spam email in step 208. The conditions for identifying spam email can be set in advance by the user. Those conditions are detailed in the following paragraph and in FIG. 3. If an email is not identified as a spam email, the email is stored in the email client computer 102 in step 210.

If the email is identified as a spam email in step 208, the sender identity of the email is retrieved in step 212. The sender identity of an email can comprise the sender name, the email address of the sender, the IP address of the sender computer, or the composition thereof. The number of spam emails received from the same sender identity is then accumulated in step 214 to see how many times spam emails have been sent from the same sender identity. If the number of spam email from the sender identity in step 214 is larger than a threshold value (for examples, 5 times) in step 216, a warning message is issued in step 218. The warning message in step 218 can be a request sent to the second mail server 116 for prohibiting the sender from sending spam emails. For example, step 218 can send an email in accordance with a standard format to the mail box of an administrator of the second mail server 116. The warning message in step 218 can also be a notice of accusation sent to the network police. For example, step 218 can send an email in accordance with a standard format to the mail server 140 of the network police to accuse the sender of sending spam email.

After the handling of an email in step 204 to 218, the mail box on the receiver server 106 is checked to see whether there are still emails not yet received by the receiver email client computer 102 in step 220. If there are still emails not received by the email client computer 102, the method 200 will continue executing step 204 to receive another email from the mail box on the server 106. If there is no email not received by the email client computer 102, the first mail server 106 is asked to delete all the emails stored in the mail box owned by the user in step 222. The method 200 ends with step 224, and the connection between the email client computer 102 and mail server 106 is cut off.

FIG. 3 is a flowchart illustrating an embodiment of a method 300 for identifying spam emails. The method 300 can be executed in the step 208 in FIG. 2. Before identifying a spam email, the condition to classify an email as a spam email must be set by the user. There are 2 judgment conditions in this embodiment : white list and key words. The email waiting for identification is read first in step 302. The first judgment condition of method 300 is then used to identify spam email in step 304, and it is the white list comprising the sender name, the email address of the sender, the IP address of the sender computer, or the composition thereof. If the sender identity of the email exists in the white list, the email waiting for identification will not be identified as a spam email in step 310. If the sender identity of the email does not exist in the white list or keyword, the second judgment condition of method 300, is then used to identify spam email in step 306. If the title or context of the email includes keywords set by the user, the email waiting for identification will be identified as a spam email in step 308. Otherwise the email is identified as a valid email in step 310.

Although there are only two judgment conditions in steps 304 and 306 in method 300, these conditions are only an illustrative example and should not be taken as limitations of this invention. There can be more conditions to improve the precision of identification of spam emails. Moreover, the white list in step 304 may comprise of several kinds of sender identities. For example, a white list comprises the sender name and the email address of the sender which can filter out the email with the same sender name but with different email addresses, and a white list comprising the sender name and the IP address of the sender computer can filter out the emails with the same sender name but with different IP addresses. Such email can also be identified as a spam email.

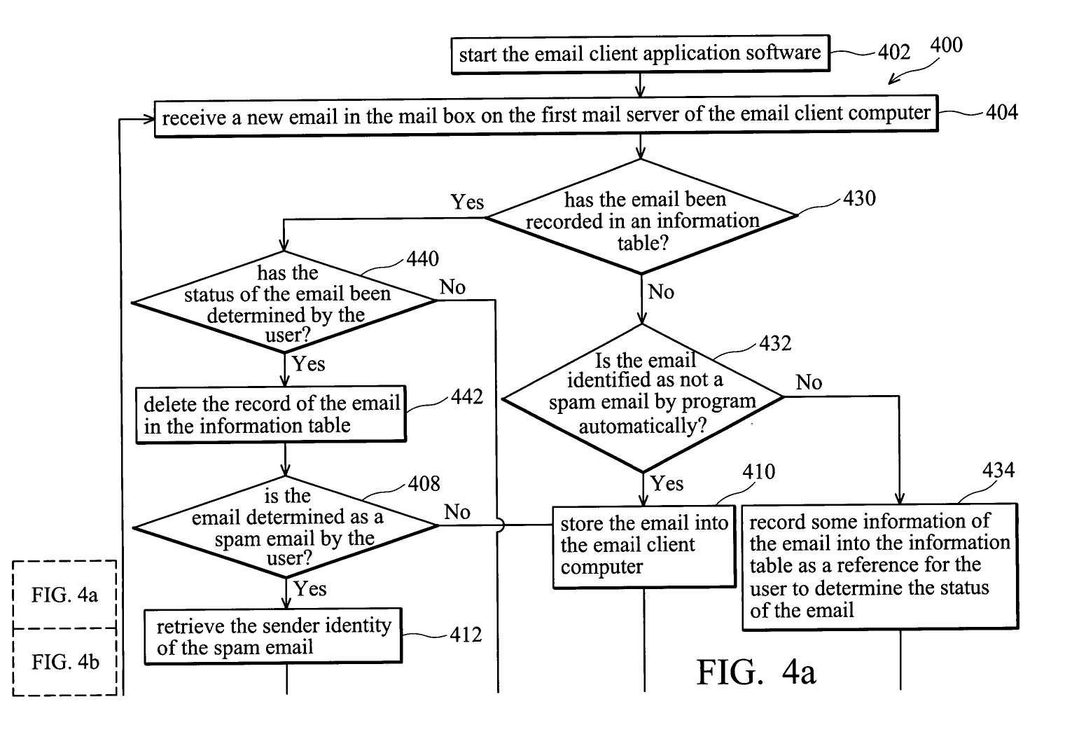

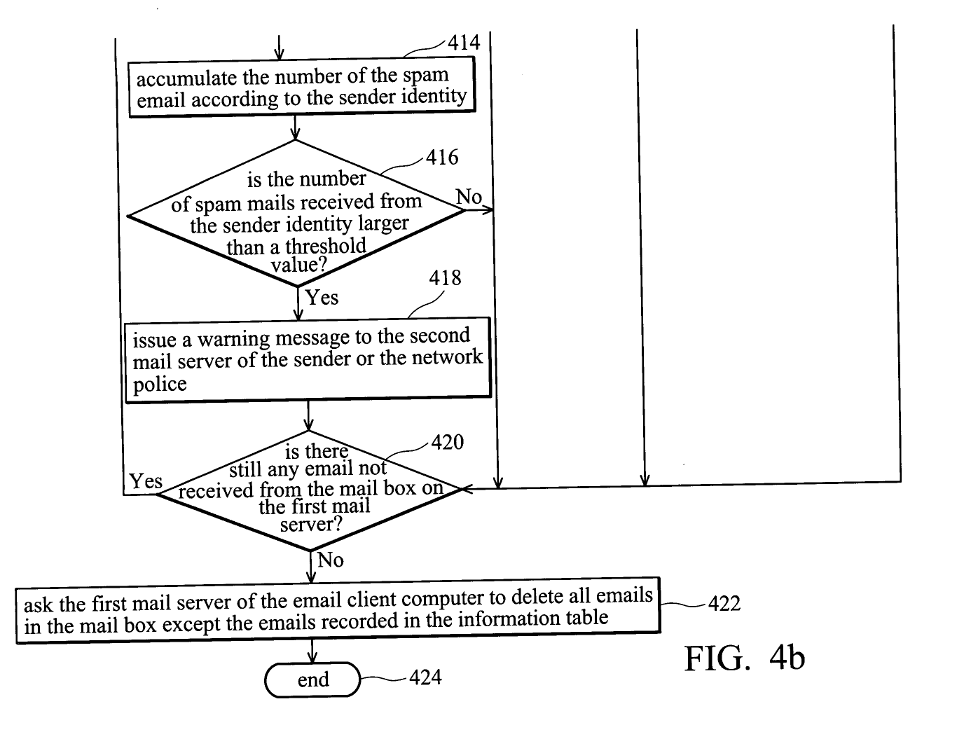

FIG. 4 is a flowchart illustrating another embodiment of a method 400 for handling spam emails according to the invention. Method 400 is similar to method 200 in FIG. 2 and can be executed by an email client software on the email client computer 102 directly or by a plug-in module for the email client software to handle spam emails. The difference between methods 200 and 400 is that there are more steps in method 400, and the augmented steps include steps 430, 432, 434, 440, and 442. The purpose to augment these steps is to download some information of an email which cannot be classified with certainty as a spam email, and the user can determine whether the email is a spam email according to the later downloaded information.

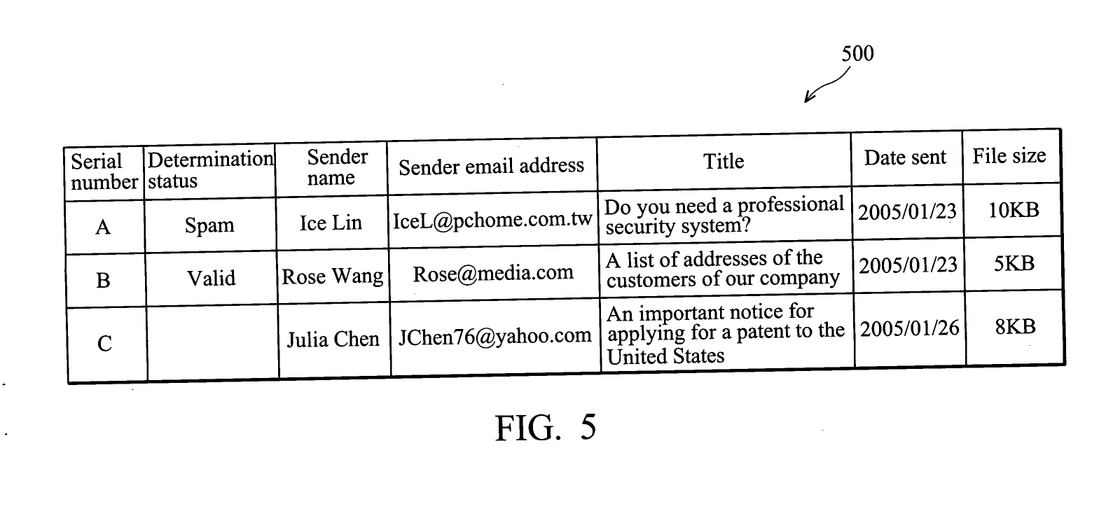

Thus, there must be a table to hold the downloaded information of the emails which cannot be classified with certainty as a spam email. FIG. 5 shows an embodiment of an information table 500 to hold the downloaded information. There are three rows in the information table 500, and each row corresponds to an email waiting for the user to determine its status. The serial numbers of these emails are A, B, and C, respectively. There are seven columns in the information table 500, and each column represents some kind of information of the emails. The information in these columns is only for illustrative example and should not be taken as a limitation of the invention. The number of information columns in table 500 can be adjusted according to user requirements. The first column is the serial number of an email. The second column is the status of an email determined by the user. The following three statuses are applicable: undetermined (empty in table 500), spam, or not spam. The third column is the sender name, the fourth column is a sender email address, the fifth column is the title of the email, the sixth column is the date sent, and the seventh column is the file size of the email. The determined status of the second column is detailed in the following. Mail A is determined by the user as a spam email, thus the determined status of mail A is “spam”. Mail B is determined by the user as not a spam email, thus the determined status of mail B is “not spam”. Mail C has not been determined by the user, so the determined status of mail C is empty. The information table 500 can be displayed on the screen of the email client computer 102 to be browsed and determined by the user after the email client software is started.

Please refer to FIG. 4. The step of method 400 will be detailed in the following. The email client software is started in step 402. A connection is then built between the email client computer 102 and first mail server 106. Method 400 then starts to receive the emails in the mail box on the first mail server 106 in step 404. Each time an email is received, the method 400 checks whether the email has been recorded in the information table 500 in step 430. If the email has not been recorded in the information table 500, the email is new and sent after the last email download. Thus the email will be automatically identified as a spam email by the program in step 432.

Step 432 resembles step 208 of method 200, and the judgment conditions can be set in advance by the user. Step 432 can be executed with method 300 in FIG. 3, but the step 308 of method 300 is changed to “the email waiting for identification will be identified as an undetermined mail”, because if the judgment conditions of steps 304 and 306 are not sufficient to identify the email as a spam email with certainty, the email will be classified as an undetermined mail and wait for the user to determine its status. Thus, if the email is identified as a valid email by the program automatically in step 432, the email is stored into the email client computer 102 in step 410. Otherwise, if the email is identified as an undetermined mail by the program automatically in step 432, a portion of information of the email is stored in the information table 500 in step 434 as a reference for the user to determine its status. If there is still any email not received by email client computer 102 in step 420, the next email is then received in step 404.

However, if the email existed in information table 500 in step 430, the necessary information of the email has been downloaded into the information table 500 the last time the email client software was active. The column of determined status of this email is checked to see whether the status of this email has been determined by the user in step 440. If the status of this email has not been determined by the user, nothing is done to this email and the method 400 progresses to step 420. If the status of this email has been determined by the user, the record of this email in the information table 500 is deleted in step 442 after storing the determined status of this email as a determined status parameter.

If the determined status parameter shows that the email is not determined as a spam email by the user in step 408, the email is stored into the email client computer 102 in step 410. If the determined status parameter shows that the email is determined as a spam email by the user in step 408, the sender identity of the email is retrieved in step 412. The sender identity of an email may comprise the sender name, the email address of the sender, the IP address of the sender computer, or the composition thereof. The number of spam emails received from the same sender identity is then accumulated in step 414 to see how many times spam emails have been sent from the same sender identity. If the number of spam email from the sender identity in step 414 is larger than a threshold value (for examples, 5 times) in step 416, a warning message is issued in step 418. The warning message in step 418 can be a request sent to the second mail server 116 for prohibiting the sender from sending spam emails. For example, step 418 may send an email in accordance with a standard format to the mail box of an administrator of the second mail server 116. The warning message in step 418 may also be a notice of accusation sent to the network police. For example, step 418 may send an email in accordance with a standard format to the mail server 140 of the network police to accuse the sender of sending spam emails.

The mail box on the receiver server 106 is checked to see whether there are still emails not yet received by the email client computer 102 in step 420. If there are still emails not received by the email client computer 102, the method 400 will continue executing step 404 to receive another email from the mail box on the server 106. If there is no email not received by the email client computer 102, the first mail server 106 is asked to delete all the emails stored in the mail box owned by the user in step 422, except for the emails recorded in the information table 500. The method 400 ends with step 424, and the connection between the email client computer 102 and mail server 106 is cut off.

This invention provides the function of analyzing the sender identity of spam emails and automatically accusing the sender of spam emails in the form of a spam email filtering module which can be a built-in or plug-in program for a email client software. Thus, the spam email filtering module in the email client software can cooperate with the email server to form an effective mechanism against spam emails

Finally, while the invention has been described by way of example and in terms of the above, it is to be understood that the invention is not limited to the disclosed embodiment. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method for handling spam emails, executed by an email client computer connected to a first mail server and comprising the steps of:
identifying an email received from the first mail server as a spam email or not a spam email according to at least one judgment condition;
accumulating a number of spam emails received from the same sender identity as the sender identity of the email if the email is identified as a spam email; and
issuing a warning message about the sender identity to a second mail server of the sender of the email or a network police if the number of spam emails is larger than a threshold value.

2. The method according to claim 1, wherein the warning message to the second mail server of the sender is an email to the administrator of the second mail server for requesting the second mail server to prohibit the sender from sending spam emails.

3. The method according to claim 1, wherein the warning message to the network police is an email for accusing the sender of sending spam emails.

4. The method according to claim 1, further comprising the step of: retrieving some information of the email from a first mail server of the email client computer as a reference for a user of the email client computer to determine whether the email is a spam email when the at least one judgment condition is not sufficient to identify the email as a spam email.

5. The method according to claim 4, wherein the some information is selected from a group including sender name, sender email address, title, date sent, file size, and a combination thereof.

6. The method according to claim 1, wherein the sender identity is selected from a group including sender name, sender email address, IP address of sender mail server, and a combination thereof.

7. The method according to claim 1, wherein the at least one judgment condition includes a white list and keywords, and the email is identified as not a spam email if the sender identity of the email exists in the white list or the keywords do not appear in the context and title of the email.

8. The method according to claim 7, wherein the white list is set according to a group including sender name, sender email address, IP address of sender mail server, and a combination thereof.

9. The method according to claim 8, wherein the email is identified as a spam email in one of the following conditions:
first condition: the white list is set according to sender name and sender email address, and if either the sender name or the sender email address of the email is not in the white list;
second condition: the white list is set according to sender name and IP address of sender mail server, and if either the sender name or the IP address of the sender mail server of the email is not in the white list; and
third condition: the white list is set according to sender email address and IP address of sender mail server, and if either the IP address of the sender mail server or the sender email address of the email is not in the white list.

10. A program for handling spam emails, loaded into an email client computer connected to a first mail server and comprising:
instructions for directing the email client computer to identify an email received from the first mail server as a spam email or not a spam email according to at least one judgment condition;
instructions for directing the email client computer to accumulate a number of spam emails received from the same sender identity as the sender identity of the email if the email is identified as a spam email; and
instructions for directing the email client computer to issue a warning message about the sender identity to a second mail server of the sender of the email or a network police if the number is larger than a threshold value.

11. The program according to claim 10, wherein the program is a built-in or plug-in module of an email client application software executed by the email client computer for receiving and sending emails.

12. The program according to claim 10, wherein the warning message to the second mail server of the sender is an email to the administrator of the second mail server for requesting the second mail server to prohobit the sender from sending spam email.

13. The program according to claim 10, wherein the warning message to the network police is an email for accusing the sender of sending spam emails.

14. The program according to claim 10, wherein the program further comprises instructions for directing the email client computer to retrieve some information of the email from-the first mail server of the email client computer as a reference for a user of the email client computer to determine whether the email is a spam email by himself when the at least one judgment condition is not sufficient to identify the email as a spam email.

15. The program according to claim 14, wherein the some information is selected from a group including sender name, sender email address, title, date sent, file size, and a combination thereof.

16. The program according to claim 10, wherein the sender identity is selected from a group including sender name, sender email address, IP address of sender mail server, and a combination thereof.

17. The program according to claim 10, wherein the at least one judgment condition includes a white list and keywords, and the email is identified as not a spam email if the sender identity of the email exists in the white list or the keywords do not appear in the context and title of the email.

18. The program according to claim 17, wherein the white list is set according to a group including sender name, sender email address, IP address of sender mail server, and a combination thereof.

19. The program according to claim 18, wherein the email is identified as a spam email in one of the following conditions:
first condition: the white list is set according to sender name and sender email address, and if either the sender name or the sender email address of the email is not in the white list;
second condition: the white list is set according to sender name and IP address of sender mail server, and if either the sender name or the sender email address of the email is not in the white list; and
third condition: the white list is set according to sender email address and IP address of sender mail server, and if either the IP address of the sender mail server or the sender email address of the email is not in the white list.
